(19) United States
(12) Patent Application Publication
(10) Pub. No.: US 2003/0012021 A1
(43) Pub. Date: Jan. 16, 2003

(54) Support piece for decorative lamp

(76) Inventor: Li-Jun Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,712

(22) Filed: Jul. 11, 2001

(51) Int. Cl. F21S 13/14; F21S 6/00

(52) U.S. Cl. 362/249; 362/123; 362/252; 362/806

(57) ABSTRACT

A support piece for at least one decorative lamp includes a body having at least one clip for holding the decorative lamp. And the body is formed with at least two connectors at ends thereof.

### BACKGROUND OF THE INVENTION

1. Field of the Invention

The present invention relates to a support piece and, more particularly, to a support piece for decorative lamp.

2. Description of Related Art

It is often found that decorative lamps are glowing in trees at nights of festivals, especially in Christmas Eve, to bring about a more joyful and more exciting atmosphere. These lamps are generally electrically connected in series by power cords which are arranged either as a single strand or as webs of various types.

FIG. 8 shows such a web which is formed by a main cord (80) and a plurality of drooping branch cords (81), with decorative lamps (90) scattered everywhere in the web. It is common knowledge that the web is not easy to be spread properly for the cords (80, 81) usually tangle after having been taken from a container they were stored.

An integral frame for preventing the tangling is known. As shown in FIG. 9, the integral frame includes a straight hollow bar (70) for receiving a main cord (50), and a plurality of curved hollow bars (71) for receiving branch cords (51). With the frame, the cords (50, 51) will never tangle with each other or with lamps (60) but the integral frame itself takes up a large space when being in storage.

Therefore, it is an objective of the invention to provide a support piece for decorative lamp(s) to mitigate and/or obviate the aforementioned problems.

### SUMMARY OF THE INVENTION

The object of the present invention is to provide a support piece which can be connected with others to form a folding frame to support decorative lamps.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a support piece in accordance with the present invention;

FIG. 2 is a perspective view showing the piece of FIG. 1 supporting a single lamp;

FIG. 3 is a schematic view showing the support piece of FIG. 1 connected with others to form a web in a desired pattern;

FIG. 4 is a perspective view of a second embodiment of the support piece in accordance with the present invention;

FIG. 5 is a perspective view of a third embodiment of the support piece in accordance with the present invention;

FIG. 6 is a perspective view of a third embodiment of the support piece in accordance with the present invention;

FIG. 7 is a perspective view of a fifth embodiment of the support piece in accordance with the present invention; and

FIG. 8 is a schematic view showing a plurality of lamps arranged in a conventional web of cords; and

FIG. 9 is a schematic view of a conventional integral frame with a plurality of lamps and cords arranged therein.

### DETAILED DESCRIPTION OF THE PREFERRED EMBODIMENT

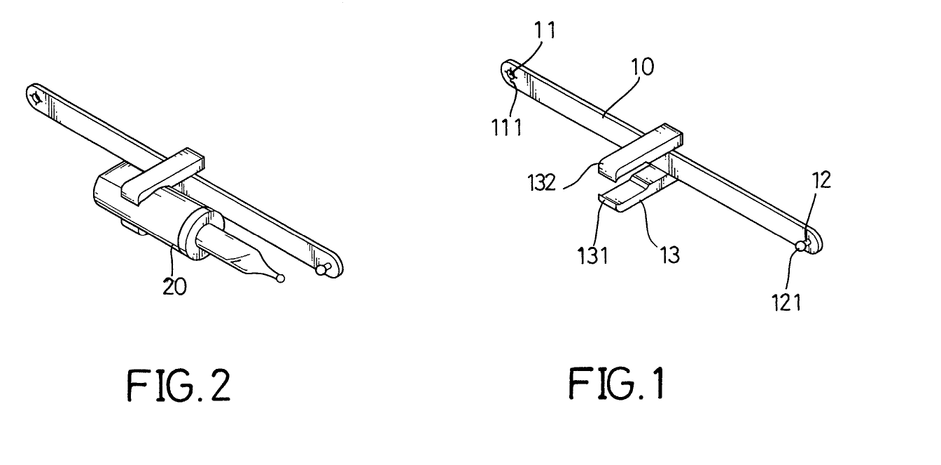

FIGS. 1 and 2 show a first embodiment of a support piece in accordance with the present invention for a decorative lamp (20).

The support piece includes an elongated body (10) having a clip (13) for holding the lamp (20), as shown in FIG. 2. Preferably, the clip (13) is formed by a pair of resiliently flexible parts (132) extending from the body (10) with opposed edges (131) formed at distal ends of the parts (132).

In addition, the elongated body (10) is formed, at ends thereof, with two connectors, one as a hole (11) with a plurality of slits (111) around, and the other as a post (12) with a knob (121) at a top end thereof.

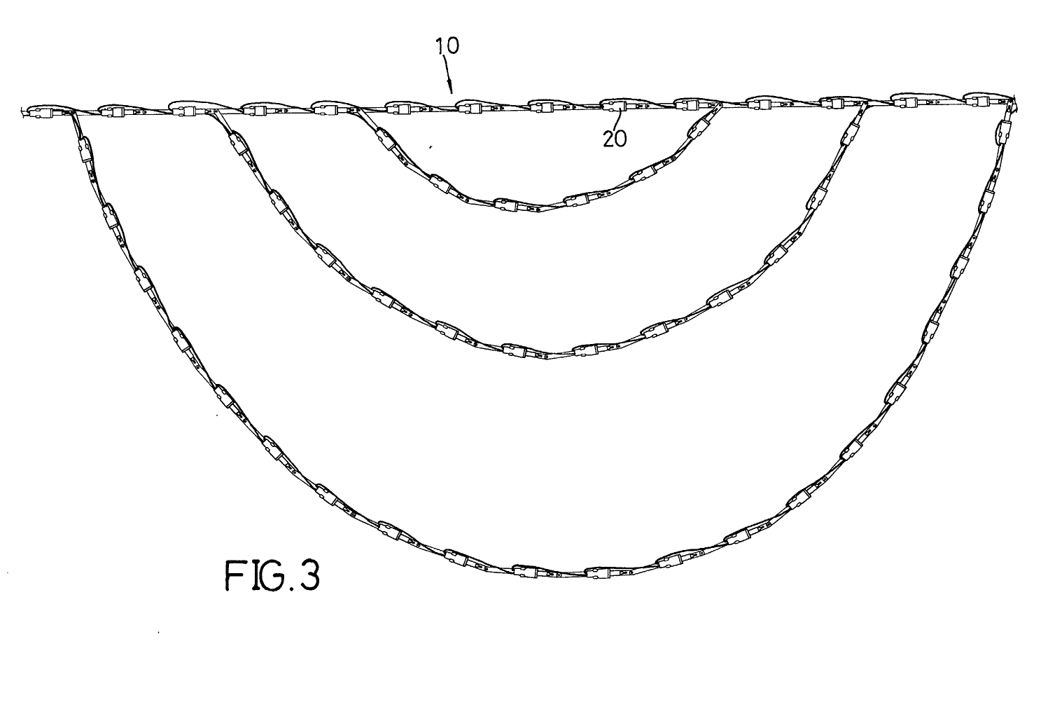

The support pieces of this type can be connected in series into a desired pattern, such as one illustrated in FIG. 3, by snapping the knob (121) of the post (12) of one piece through the hole (11) of another piece. It is apparent that the splits (111) are helpful to the snapping of the knot (121) through the hole (11).

The lamps (20) are then held one by one in the respective clips (13) between their parts (132) and retained in place there by their edges (131).

Due to the connections between the pieces, the assembly of the pieces and hence of the lamps (20) can be collapsed when intended to be stored, and can be expanded easily and quickly when intended to be put into use.

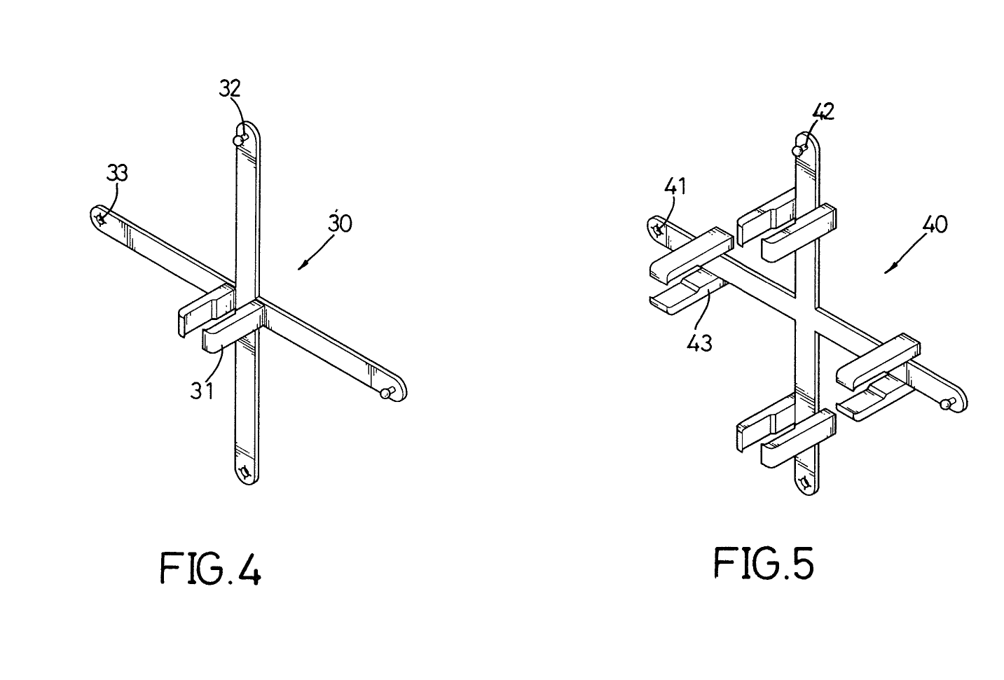

FIG. 4 shows a second embodiment of the support piece in accordance with the present invention. This support piece includes a cross body (30) having a clip (31) formed at a center thereof with connectors, either as posts (32) or as holes (33), formed at ends of the cross body (30).

FIG. 5 shows a third embodiment of the support piece in accordance with the present invention. The support piece here also includes a cross body (40) formed at its ends with connectors in the forms of holes (41) and posts (42), but with four clips (43) adjacent to respective connectors.

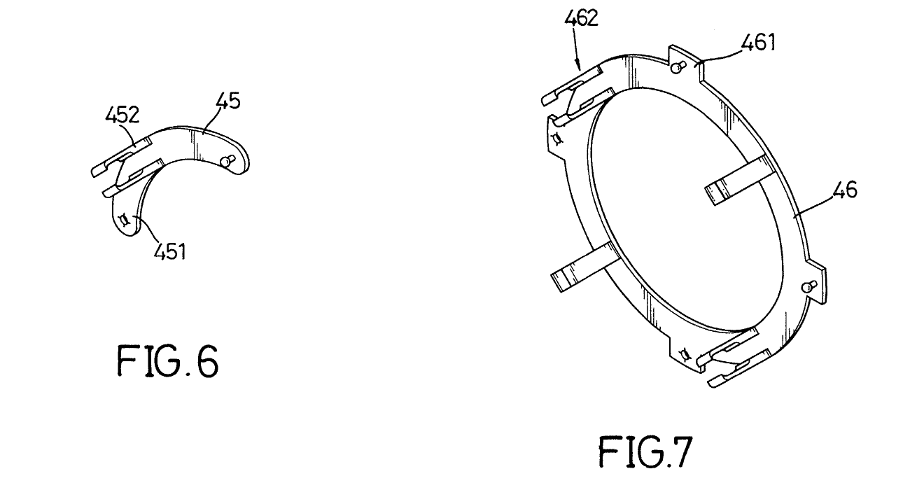

FIG. 6 shows a fourth embodiment of the support piece, in accordance with the present invention, which includes an arc body (45) formed with two connectors (451) at ends thereof and with a clip (452) between the connectors (451).

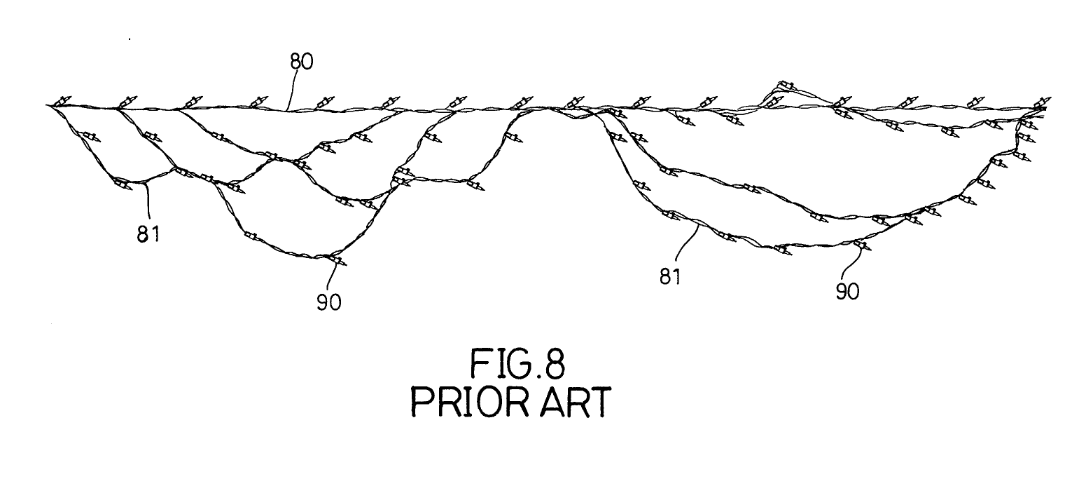

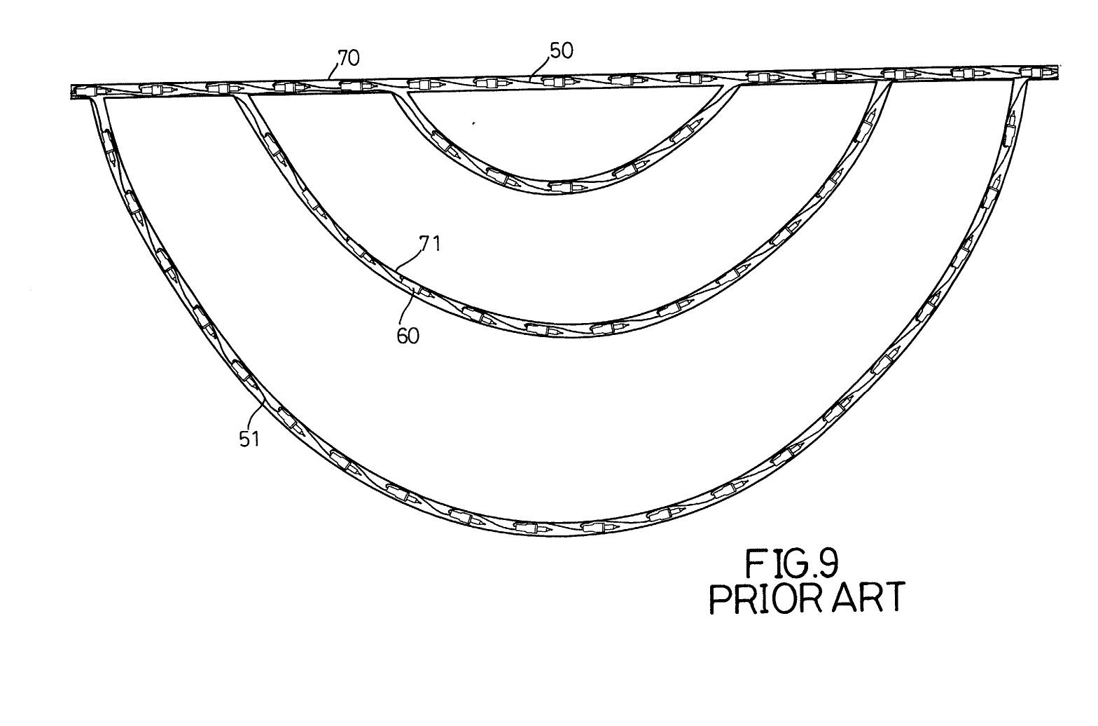

FIG. 7 shows a fifth embodiment of the support piece that includes an annular body (46) formed with four connectors (461) and four clips (462).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A support piece for at least one decorative lamp, comprising a body (10, 30, 40, 45, 46) having at least one clip (13, 31, 43, 452, 462) for holding said at least one decorative lamp, and said body (10, 30, 40, 45, 46) being formed with at least two connectors (451, 461) at ends thereof.

2. The support piece as claimed in claim 1, wherein one of said connectors is embodied as a hole (11), and wherein the other one of said connectors (451, 461) is embodied as a post (12) formed with a knob (12) incorporated to said hole (11).

3. The support piece as claimed in claim 2, wherein said body (10, 30, 40, 45, 46) has a plurality of radial slits (111) around said hole (11).
